(19) United States
(12) Patent Application Publication
(10) Pub. No.: US 2024/0301789 A1
(43) Pub. Date: Sep. 12, 2024

(54) CALIBRATED MINERALOGY INTERPRETATION METHODS AND RELATED COMPUTER SYSTEMS

(71) Applicant: ExxonMobil Technology and Engineering Company, Spring, TX (US)

(72) Inventors: Mathilde LUYCX, Houston, TX (US); Olabode IJASAN, The Woodlands, TX (US); Darren M. MCLENDON, Houston, TX (US); Brent D. WHEELOCK, Lebanon, NJ (US)

(21) Appl. No.: 18/259,024

(22) PCT Filed: Nov. 8, 2021
(86) PCT No.: PCT/US2021/072275

§ 371 Date: Jun. 22, 2023

Related U.S. Application Data
(60) Provisional application No. 63/199,519, filed on Jan. 5, 2021.

(51) Int. Cl. E21B 49/00; E21B 47/003; G01V 13/00

(52) U.S. Cl. CPC E21B 49/003; E21B 47/003; G01V 13/00

(57) ABSTRACT

A method for calibrated multi-mineral, multi-fluid interpretation is provided herein. The method includes generating a multi-mineral, multi-fluid interpretation model for a number of log types using core and/or specialized log data acquired from subsurface region(s) that relate to components within the subsurface region(s). Generating the model includes: (1) for each log type, calibrating component end-members for the log type via an inversion of the core and/or specialized log data relating to the components across all depths of interest; and (2) incorporating the resulting calibrated end-members for the log types into the model. The method also includes generating component volume fraction profiles using log data acquired from analogous subsurface region(s) using the model, wherein the log data relate to any of the log types used to generate the model. Each component volume fraction profile includes a range of component volume fractions that accounts for a degree of uncertainty within the model.

### CROSS REFERENCE TO RELATED APPLICATIONS

This application is the U.S. National Stage Application of the International Application No. PCT/US2021/072275, entitled “CALIBRATED MINERALOGY INTERPRETATION METHODS AND RELATED COMPUTER SYSTEMS,” filed on Nov. 8, 2021, the disclosure of which is hereby incorporated by reference in its entirety, which claims benefit of U.S. Provisional Patent Application Ser. No. 63/199,519, entitled “Calibrated Mineralogy Interpretation Techniques,” filed Jan. 5, 2021, the disclosure of which is hereby incorporated by reference in its entirety.

### FIELD OF THE INVENTION

The techniques described herein relate to the oil and gas field and, more specifically, to geophysical prospecting. More particularly, the techniques described herein relate to calibrated mineralogy interpretation techniques for producing multi-mineral, multi-fluid interpretation models.

### BACKGROUND OF THE INVENTION

This section is intended to introduce various aspects of the art, which may be associated with embodiments of the present techniques. This discussion is believed to assist in providing a framework to facilitate a better understanding of particular aspects of the present techniques. Accordingly, it should be understood that this section should be read in this light, and not necessarily as admissions of prior art.

Geophysical prospecting is commonly performed in the oil and gas industry to quantify component (i.e., mineral, organic matter, and/or fluid) compositions and concentrations within a formation surrounding a hydrocarbon well. Such geophysical prospecting typically involves using a logging tool, such as a neutron porosity logging tool, for example, to collect log data relating to the geophysical properties of the formation. In addition, core samples are often collected from wells, and core data relating to the petrophysical and mineralogical properties of the formations surrounding the wells are extracted from the core samples. Mineralogy interpretation techniques may then use the log data or core data, or some combination thereof, to quantify the component compositions and concentrations within the formation surrounding the well.

Existing mineralogy interpretation techniques accomplish this goal by producing multi-mineral, multi-fluid interpretation models that relate rock matrix and fluid components to well-log measurements at each measurement depth k, using tool-response equations of the form shown in Equation (1).

$${\tilde{d}}_{l}^{k} = {\sum }_{i}^{I} {R}_{l , i} {v}_{i}^{k} \qquad ( 1 )$$

In Equation (1), vᵢ^{k} represents the volume fraction of component i of I constituents of the rock at depth k; R_{l,i} represents the end-member responses of the measurement l for constituent i; and d represents the measurement obtained from the log data (also referred to as the “log response”). Several existing algorithms are available to solve Equation (1) for the constituent volume fractions vᵢ, by attempting to reconstruct the set of input log responses d. These algorithms rely on the use of pre-defined end-members R_{l,i}, for each measurement l, and constituent i. However, in practice, such end-members vary depending on various factors relating to the environment in which the well-log measurements are obtained, as well as the particular logging techniques used to obtain the well-log measurements. For example, such end-members may vary depending on the environment of deposition, the rock provenance, the rock fabric, well-log environmental corrections, and even the design of the particular logging tool used to obtain the well-log measurements. Therefore, according to existing mineralogy interpretation techniques, the end-members are usually updated by way of manual iterations until the interpreted component volumes match the core measurements.

Because the interpreted component volumes are the benchmark for selecting end-members, it is possible to identify a combination of end-members that satisfy the core data without capturing the underlying physics of each measurement. As a result, this methodology for identifying end-members limits the ability to interpret new measurements using the same interpretation model, since each interpretation model is benchmarked for a certain set of end-members and measurements. Furthermore, the end-members often have to be updated as new measurements become available, thus casting doubt on the interpretation model's ability to accurately predict the component volumes. Accordingly, existing mineralogy interpretation techniques generally produce interpretation models that are poorly-defined, tediously manual and iterative, and often ineffective.

### SUMMARY OF THE INVENTION

An embodiment described herein provides a method for calibrated multi-mineral, multi-fluid interpretation. The method includes generating, via a computing system, a multi-mineral, multi-fluid interpretation model for a number of log types using at least one of core data or specialized log data acquired from one or more subsurface regions, wherein the at least one of the core data or the specialized log data relate to components within the one or more subsurface regions, and wherein generating the multi-mineral, multi-fluid interpretation model includes: (1) for each log type, calibrating component end-members for the log type via an inversion of the at least one of the core data or the specialized log data relating to the components across all depths of interest; and (2) incorporating the resulting calibrated end-members for the log types into the multi-mineral, multi-fluid interpretation model. The method also includes generating, via the computing system, component volume fraction profiles using log data acquired from one or more analogous subsurface regions using the multi-mineral, multi-fluid interpretation model, wherein the log data relate to any of the log types used to generate the multi-mineral, multi-fluid interpretation model, and wherein each component volume fraction profile includes a range of possible component volume fractions that accounts for a degree of uncertainty within the multi-mineral, multi-fluid interpretation model.

In various embodiments, generating the multi-mineral, multi-fluid interpretation model further includes performing the following during calibration of the end-members: (1) generating one or more linear regressions between at least two of the component volume fractions obtained from the core data and/or the specialized log data, and/or between at least one of the component volume fractions obtained from the core data and/or the specialized log data and additional log data acquired at corresponding depths of interest within the one or more subsurface regions; (2) determining whether each of the one or more linear regressions represents a valid empirical relationship between at least two of the component volume fractions obtained from the core data and/or the specialized log data, and/or between at least one of the component volume fractions obtained from the core data and/or the specialized log data and the additional log data acquired at corresponding depths of interest within the one or more subsurface regions; and (3) reducing the degree of uncertainty within the multi-mineral, multi-fluid interpretation model by augmenting the multi-mineral, multi-fluid interpretation model with any of the one or more linear regressions that represent the valid empirical relationships.

In some embodiments, the method also includes re-calibrating the end-members in response to an addition of at least one of new core data or new specialized log data corresponding to at least one of an additional subsurface region or an additional depth of interest. Moreover, in some embodiments, the method also includes expanding the multi-mineral, multi-fluid interpretation model by calibrating additional end-members in response to at least one of: (1) acquiring an additional log type; or (2) identifying additional components by acquiring at least one of new core data or new specialized log data.

In various embodiments, the method includes generating the component volume fraction profiles via an inversion of the log data acquired from the one or more analogous subsurface regions using the multi-mineral, multi-fluid interpretation model. Moreover, in various embodiments, the method includes identifying the range of possible component volume fractions for each component by selecting the range of component volume fractions that minimizes an overall data misfit within results obtained using the multi-mineral, multi-fluid interpretation model. In such embodiments, identifying the range of possible component volume fractions for each component may include at least one of: (1) identifying the component volume fractions that satisfy a desired level of χ-squared misfit; or (2) calculating a χ-squared minimum plateau for the component volume fractions and deriving a lower bound and an upper bound for the component volume fractions based on the χ-squared minimum plateau.

In some embodiments, the log types include any combination of a reconstructed bulk density (RHOB) log type, a gamma ray (GR) log type, a neutron porosity (PHIN) log type, a compressional slowness (DTCO) log type, a photoelectric absorption (U) log type, a shear acoustic (DTSH) log type, a photoelectric factor (PE) log type, a resistivity log type, a conductivity log type, a spectral gamma ray log type, a capture cross-section (SIGMA) log type, or an elemental spectroscopy log type. In some embodiments, the core data include at least one of core X-ray diffraction (XRD) data, core total organic carbon (TOC) data, or porosity and saturation data derived from conventional or crushed rock analysis (GRI) methods. In addition, in some embodiments, the specialized log data include field-calibrated mineralogy log data interpreted using specialized spectroscopy log measurements. Furthermore, in some embodiments, the components include at least one of minerals, organic matter, or fluids; and the minerals include at least one of clay, calcite, dolomite, quartz, feldspar, pyrite, or mineral groups such as quartz-feldspar-mica or carbonate.

Another embodiment described herein provides a computing system including a processor and a non-transitory, computer-readable storage medium. The non-transitory, computer-readable storage medium includes code configured to direct the processor to generate a multi-mineral, multi-fluid interpretation model for a number of log types using at least one of core data or specialized log data acquired from one or more subsurface regions, wherein the at least one of the core data or the specialized log data relate to components within the one or more subsurface regions, and wherein generating the multi-mineral, multi-fluid interpretation model includes: (1) for each log type, calibrating component end-members for the log type via an inversion of the at least one of the core data or the specialized log data relating to the components across all depths of interest; and (2) incorporating the resulting calibrated end-members for the log types into the multi-mineral, multi-fluid interpretation model. The non-transitory, computer-readable storage medium also includes code configured to direct the processor to generate component volume fraction profiles using log data acquired from one or more analogous subsurface regions using the multi-mineral, multi-fluid interpretation model, wherein the log data relate to any of the log types used to generate the multi-mineral, multi-fluid interpretation model, and wherein each component volume fraction profile includes a range of possible component volume fractions that accounts for a degree of uncertainty within the multi-mineral, multi-fluid interpretation model.

In various embodiments, the non-transitory, computer-readable storage medium further includes code configured to direct the processor to generate the multi-mineral, multi-fluid interpretation model by: (1) generating one or more linear regressions between at least two of the component volume fractions obtained from the core data and/or the specialized log data, and/or between at least one of the component volume fractions obtained from the core data and/or the specialized log data and additional log data acquired at corresponding depths of interest within the one or more subsurface regions; (2) determining whether each of the one or more linear regressions represents a valid empirical relationship between at least two of the component volume fractions obtained from the core data and/or the specialized log data, and/or between at least one of the component volume fractions obtained from the core data and/or the specialized log data and the additional log data acquired at corresponding depths of interest within the one or more subsurface regions; and (3) reducing the degree of uncertainty within the multi-mineral, multi-fluid interpretation model by augmenting the multi-mineral, multi-fluid interpretation model with any of the one or more linear regressions that represent the valid empirical relationships.

In various embodiments, the non-transitory, computer-readable storage medium also includes code configured to direct the processor to identify the range of possible component volume fractions for each component by selecting the range of component volume fractions that minimizes an overall data misfit within results obtained using the multi-mineral, multi-fluid interpretation model. In such embodiments, the non-transitory, computer-readable storage medium may include code configured to direct the processor to identify the range of possible component volume fractions for each component by performing at least one of: (1) identifying the component volume fractions that satisfy a desired level of χ-squared misfit; or (2) calculating a χ-squared minimum plateau for the component volume fractions and deriving a lower bound and an upper bound for the component volume fractions based on the χ-squared minimum plateau.

In some embodiments, the non-transitory, computer-readable storage medium includes code configured to direct the processor to re-calibrate the end-members in response to an addition of at least one of new core data or new specialized log data corresponding to at least one of an additional subsurface region or an additional depth of interest. Moreover, in some embodiments, the non-transitory, computer-readable storage medium includes code configured to direct the processor to expand the multi-mineral, multi-fluid interpretation model by calibrating additional end-members in response to at least one of: (1) acquiring an additional log type; or (2) identifying additional components by acquiring at least one of new core data or new specialized log data.

Another embodiment described herein provides a non-transitory, computer-readable storage medium including program instructions that are executable by a processor to cause the processor to generate a multi-mineral, multi-fluid interpretation model for a number of log types using at least one of core data or specialized log data acquired from one or more subsurface regions, wherein the at least one of the core data or the specialized log data relate to components within the one or more subsurface regions, and wherein generating the multi-mineral, multi-fluid interpretation model includes: (1) for each log type, calibrating component end-members for the log type via an inversion of the at least one of the core data or the specialized log data relating to the components across all depths of interest; and (2) incorporating the resulting calibrated end-members for the log types into the multi-mineral, multi-fluid interpretation model. The non-transitory, computer-readable storage medium also includes program instructions that are executable by a processor to cause the processor to generate component volume fraction profiles using log data acquired from one or more analogous subsurface regions using the multi-mineral, multi-fluid interpretation model, wherein the log data relate to any of the log types used to generate the multi-mineral, multi-fluid interpretation model, and wherein each component volume fraction profile includes a range of possible component volume fractions that accounts for a degree of uncertainty within the multi-mineral, multi-fluid interpretation model.

In various embodiments, the non-transitory, computer-readable storage medium also includes program instructions that are executable by the processor to cause the processor to generate the multi-mineral, multi-fluid interpretation model by: (1) generating one or more linear regressions between at least two of the component volume fractions obtained from the core data and/or the specialized log data, and/or between at least one of the component volume fractions obtained from the core data and/or the specialized log data and additional log data acquired at corresponding depths of interest within the one or more subsurface regions; (2) determining whether each of the one or more linear regressions represents a valid empirical relationship between at least two of the component volume fractions obtained from the core data and/or the specialized log data, and/or between at least one of the component volume fractions obtained from the core data and/or the specialized log data and the additional log data acquired at corresponding depths of interest within the one or more subsurface regions; and (3) reducing the degree of uncertainty within the multi-mineral, multi-fluid interpretation model by augmenting the multi-mineral, multi-fluid interpretation model with any of the one or more linear regressions that represent the valid empirical relationships. Furthermore, in various embodiments, the non-transitory, computer-readable storage medium includes program instructions that are executable by the processor to cause the processor to identify the range of possible component volume fractions for each component by selecting the range of component volume fractions that minimizes an overall data misfit within results obtained using the multi-mineral, multi-fluid interpretation model.

### DESCRIPTION OF THE DRAWINGS

Advantages of the present techniques may become apparent upon reviewing the following detailed description and drawings of non-limiting examples in which:

FIG. 1A is a graph of a linear regression that represents a potential empirical relationship between the component volume fraction of pyrite and the component volume fraction of clay;

FIG. 1B is a graph of a linear regression that represents a potential empirical relationship between the bulk density (RHOB) log measurements and the component volume fraction of kerogen;

FIG. 1C is a graph of a linear regression that represents a potential empirical relationship between the core total organic carbon (TOC) data and the component volume fraction of pyrite;

FIG. 2A includes graphs comparing the actual log measurements for each log type to the log measurements predicted using the default end-members and the component volume fractions from core measurements, and the log measurements predicted using the calibrated end-members and the component volume fractions from core measurements;

FIG. 2B includes graphs showing cross plots of the log measurements for each log type, wherein the graphs include a comparison of particular measured log measurements against particular log measurements predicted using the default end-members and the component volume fractions from core measurements, and log measurements predicted using the calibrated end-members and the component volume fractions from core measurements;

FIG. 3 is a graph showing the manner in which the lowest misfit for each component volume fraction may be determined for the exemplary implementation of the calibrated mineralogy interpretation techniques described herein;

FIG. 4 includes graphs showing the component volume fraction profiles for the exemplary implementation of the calibrated mineralogy interpretation techniques described herein;

FIG. 5 is a process flow diagram of a method for calibrated multi-mineral, multi-fluid interpretation;

FIG. 6 is a block diagram of an exemplary cluster computing system that may be utilized to implement the calibrated mineralogy interpretation techniques described herein; and

FIG. 7 is a block diagram of an exemplary non-transitory, computer-readable storage medium that may be used for the storage of data and modules of program instructions for implementing the calibrated mineralogy interpretation techniques described herein.

It should be noted that the figures are merely examples of the present techniques and are not intended to impose limitations on the scope of the present techniques. Further, the figures are generally not drawn to scale, but are drafted for purposes of convenience and clarity in illustrating various aspects of the techniques.

### DETAILED DESCRIPTION OF THE INVENTION

In the following detailed description section, the specific examples of the present techniques are described in connection with preferred embodiments. However, to the extent that the following description is specific to a particular embodiment or a particular use of the present techniques, this is intended to be for example purposes only and simply provides a description of the embodiments. Accordingly, the techniques are not limited to the specific embodiments described below, but rather, include all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, the terms “a” and “an” mean one or more when applied to any embodiment described herein. The use of “a” and “an” does not limit the meaning to a single feature unless such a limit is specifically stated.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “configured” means that the element, component, or other subject matter is designed and/or intended to perform a given function. Thus, the use of the term “configured” should not be construed to mean that a given element, component, or other subject matter is simply “capable of” performing a given function but that the element, component, and/or other subject matter is specifically selected, created, implemented, utilized, and/or designed for the purpose of performing the function.

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure or method is not intended to be limiting, required, or exclusive/exhaustive; and other components, features, structures, or methods, including structurally and/or functionally similar and/or equivalent components, features, structures, or methods, are also within the scope of the present techniques.

The term “fluid” refers to gases, liquids, and combinations of gases and liquids, as well as to combinations of gases and solids, and combinations of liquids and solids.

Unless otherwise specified, the terms “inverse problem” and “inversion” are generally used herein to refer to either a linear inverse problem or a non-linear inverse problem, depending on the details of the specific implementation.

As used herein, the term “log data” refers to data obtained from analyzing wireline or logging-while-drilling logs for one or more wells, while the term “core data” refers to data obtained from analyzing core or cutting samples collected from one or more wells. Various techniques may be used to extract log data from the wireline or logging-while-drilling logs and/or core data from the core samples. Such techniques may include, for example, digitization, resampling, extrapolation, interpolation, curve fitting, and like. Moreover, the extracted log data and/or core data represent the geophysical properties of the formation through which the one or more wells extend.

The terms “well” and “wellbore” refer to holes drilled vertically, at least in part, and may also refer to holes drilled with deviated, highly deviated, and/or lateral sections. The term also includes the wellhead equipment, surface casing string, intermediate casing string(s), production casing string, and the like, typically associated with hydrocarbon wells.

Embodiments described herein provide improved mineralogy interpretation techniques for generating and utilizing calibrated multi-mineral, multi-fluid interpretation models that are well-defined, robust, and highly-predictive. In particular, embodiments described herein provide for the generation of a calibrated multi-mineral, multi-fluid interpretation model for a set of log types using core data and/or specialized log data relating to components within one or more subsurface regions. According to embodiments described herein, this includes calibrating component end-members for the model on a log-by-log basis via an inversion of the core data and/or the specialized log data relating to the components across all depths of interest. The resulting calibrated end-members for the log types are then incorporated into the model. In various embodiments, the calibration of the end-members also allows for the automated generation of linear regressions that represent empirical relationships between component volume fractions obtained from the core data and/or the specialized log data, and/or between component volume fractions obtained from the core data and/or the specialized log data and additional log data acquired at corresponding depths of interest within the subsurface region(s).

Furthermore, embodiments described herein provide for the utilization of the resulting calibrated multi-mineral, multi-fluid interpretation model to quantify component volume fractions within one or more analogous subsurface regions using log data that are acquired from the analogous subsurface region(s) and are related to any of the log types used to generate the model. In various embodiments, this includes generating component volume fraction profiles for the components within the analogous subsurface region(s), where each component volume fraction profile includes a range of possible component volume fractions that accounts for the inherent uncertainty in the model results. Moreover, in various embodiments, any empirical relationships that were identified during the end-member calibration step may be used to augment the model and, thus, reduce the uncertainty in the model results.

### Exemplary Implementation of Calibrated Mineralogy Interpretation Techniques

As described herein, the multi-mineral, multi-fluid interpretation models produced by existing mineralogy interpretation techniques rely on the use of pre-defined end-members. However, in practice, such end-members vary depending on various factors relating to the environment in which the well-log measurements are obtained, as well as the particular logging techniques used to obtain the well-log measurements. Therefore, according to existing mineralogy interpretation techniques, the end-members are usually updated by way of manual iterations until the interpreted component volumes match the core measurements. Because the interpreted component volumes are the benchmark for selecting end-members, it is possible to identify a combination of end-members that satisfy the core data without capturing the underlying physics of each measurement. As a result, this methodology for identifying end-members limits the ability to interpret new measurements using the same interpretation model, since each interpretation model is benchmarked for a certain set of end-members and measurements. Furthermore, the end-members often have to be updated as new measurements become available, thus casting doubt on the interpretation model's ability to accurately predict the component volumes. Therefore, existing mineralogy interpretation techniques generally produce interpretation models that are poorly-defined, tediously manual and iterative, and often ineffective.

Accordingly, embodiments described herein provide improved mineralogy interpretation techniques that produce calibrated multi-mineral, multi-fluid interpretation models that are highly-robust and highly-predictive. According to embodiments described herein, this involves two steps. The first step includes generating an accurate multi-mineral, multi-fluid interpretation model by calibrating end-members for the model on a log-by-log basis using core data and/or specialized log data acquired across multiple depths within one or more subsurface regions, and (optionally) automatically generating linear regressions that represent empirical relationships between component volume fractions obtained from the core data and/or the specialized log data, and/or between the component volume fractions obtained from the core data and/or the specialized log data and additional log data acquired at corresponding depths of interest within the subsurface region(s). The second step includes using the generated model with the calibrated end-members to solve the inverse problem for quantifying component volume fractions within one or more analogous subsurface regions using log data corresponding to any of the log types used to generate the model. In various embodiments, the results obtained according to the second step are provided as component volume fraction profiles that capture the inherent uncertainty in the model, while also allowing such uncertainty to be reduced using any empirical relationships identified during the first step.

According to the exemplary implementation described herein, for the first step, it is assumed that end-members R, are constant and independent of depth k. The inverse problem shown in Equation (2) is then solved for each individual log measurement l, across a series of depths k; where the rock component volumes fractions across all depths k are elements of matrix V and fₖ(V) represents the predicted measurement response of individual log measurements l based on the volume fractions in V.

$${min}_{{R}_{l}} {‖ {d}_{l} - {f}_{l} ( V ) ‖}_{2}^{2} \qquad ( 2 )$$

Oftentimes (but not always), fₗ(V) is a linear mixing law between the component volume fractions in V and the end-members R_{l,i}; such that Equation (3) is obtained.

$${f}_{l} ( V ) = [ \begin{matrix}{v}_{1}^{1} & … & {v}_{i}^{1} & … & {v}_{I}^{1} \\ ⋮ & ⋱ & & & ⋮ \\ {v}_{1}^{k} & & {v}_{i}^{k} & & {v}_{I}^{k} \\ ⋮ & & & ⋱ & ⋮ \\ {v}_{1}^{K} & … & {v}_{i}^{K} & … & {v}_{I}^{K}\end{matrix} ] \cdot [ \begin{matrix}{R}_{l , 1} \\ ⋮ \\ {R}_{l , i} \\ ⋮ \\ {R}_{l , I}\end{matrix} ] \qquad ( 3 )$$

Under the linear mixing law assumption, the inverse problem shown in Equation (2) reduces to a linear inverse problem, and Equation (4) is obtained.

$${min}_{{R}_{l}} {‖ [ \begin{matrix}{v}_{1}^{1} & … & {v}_{i}^{1} & … & {v}_{I}^{1} \\ ⋮ & ⋱ & & & ⋮ \\ {v}_{1}^{k} & & {v}_{i}^{k} & & {v}_{I}^{k} \\ ⋮ & & & ⋱ & ⋮ \\ {v}_{1}^{K} & … & {v}_{i}^{K} & … & {v}_{I}^{K}\end{matrix} ] \cdot [ \begin{matrix}{R}_{l , 1} \\ ⋮ \\ {R}_{l , i} \\ ⋮ \\ {R}_{l , I}\end{matrix} ] - [ \begin{matrix}{d}_{l}^{1} \\ ⋮ \\ {d}_{l}^{k} \\ ⋮ \\ {d}_{l}^{K}\end{matrix} ] ‖}_{2}^{2} \qquad ( 4 )$$

In these equations, the rock is made of I components and the volume fractions vᵢ^{k}, of each component i, at each depth k, are elements of matrix V. According to embodiments described herein, the volume fractions used as input data for this calibration step can be obtained from core data or specialized log data, although core data is preferred. Examples of core data types that may be used include core X-ray diffraction (XRD) data, core total organic carbon (TOC) data, porosity, saturation, and grain density data derived from conventional and/or crushed (e.g., Gas Research Institute) rock analysis, and the like. As another example, in some embodiments, core TOC data can be replaced by TOC data calculated from log-based empirical relationships. As yet another example, in some embodiments, field-calibrated mineralogy log data interpreted using specialized spectroscopy log measurements may be used. Specific details relating to such field-calibrated mineralogy log data are provided by U.S. Pat. No. 10,705,246 B2 to Guo and Luycx, entitled “Method of Rock Mineralogy Interpretation”. Moreover, it will be understood by one of skill in the art that embodiments described herein may also utilize any other suitable type(s) of log data that can be used to quantify the volumetric concentrations of individual components within a formation. Furthermore, embodiments described herein may be performed for any suitable log types, such as, for example, reconstructed bulk density (RHOB), gamma ray (GR), neutron porosity (PHIN), compressional slowness (DTCO), photoelectric absorption (U), shear acoustic (DTSH), photoelectric factor (PE), resistivity, conductivity, spectral gamma ray, capture cross-section (SIGMA), and/or elemental spectroscopy logs.

In some embodiments, end-members are calibrated by solving Equation (2) using an inversion algorithm. In addition to minimizing Equation (2), the inversion algorithm also enforces physics-based constraints of the form lb_{l,i}<R_{l,i}≤ub_{l,i}. Moreover, there are a number of published linear and non-linear inversion solvers that may be used for this type of problem, where the performances of such solvers vary in terms of convergence speed and the ability to reach a globally optimized solution. Accordingly, a suitable linear or non-linear inversion solver may be selected depending on the details of the specific implementation.

In various embodiments, the end-member calibration of each log type is performed separately such that the inverted log-type specific end-members are exclusive and independent of the calibration results for the other log types. This log-by-log calibration allows for new log types to be included in the interpretation workflow of the second step, as long as a calibration exists. Compared to the manual updating of end-members, this workflow is faster, more predictive, and more robust because the end-members are optimized independently based on the difference between the reconstructed and measured logs, rather than on the interpreted component volume fractions.

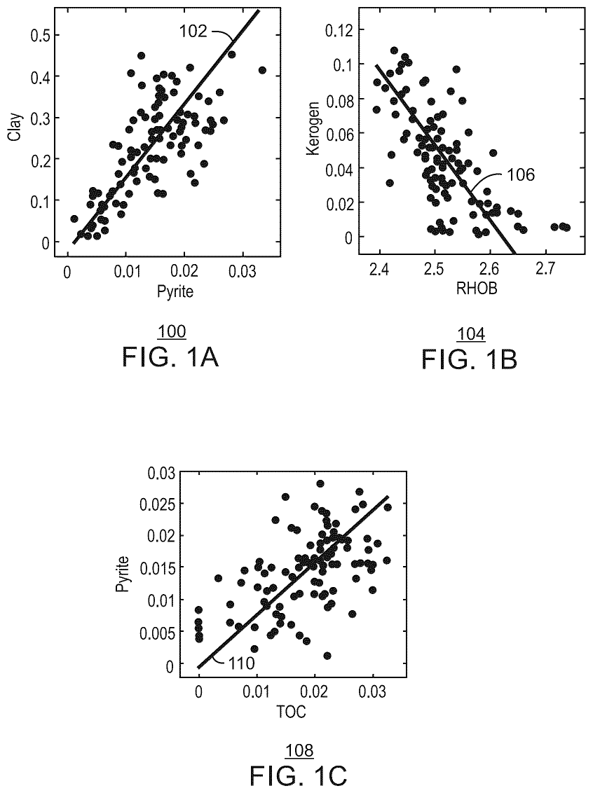

In addition to end-member calibration, the first step also allows for the automated generation of linear regressions that represent empirical relationships between particular component volume fractions obtained from the core data and/or the specialized log data, and/or between particular component volume fractions obtained from the core data and/or the specialized log data and additional log data acquired at corresponding depths of interest within the subsurface region(s). Any linear regressions that represent valid empirical relationships can then be included in the interpretation workflow of the second step. Examples of such linear regressions are shown in FIGS. 1A, 1B, and 1C. Specifically, FIG. 1A is a graph 100 of a linear regression 102 that represents a potential empirical relationship between the component volume fraction of pyrite and the component volume fraction of clay. The linear regression 102 shown in FIG. 1A includes a regression coefficient of 0.47. In various embodiments, the identified linear regression 102 is compared to the data points (represented as dots in FIG. 1A) to determine whether the linear regression 102 represents a valid, predictive empirical relationship (or interdependence) between the two component volume fractions. According to the embodiment shown in FIG. 1A, because the data points are within close proximity to the linear regression 102, the linear regression 102 does represent a valid empirical relationship that may be used to augment the multi-mineral, multi-fluid interpretation model and, thus, reduce the uncertainty in the model results obtained during the second step. Specifically, the linear regression 102 may be used as an additional equation that further constrains the problem, thus reducing the non-uniqueness of the solution.

FIG. 1B is a graph 104 of a linear regression 106 that represents a potential empirical relationship between the bulk density (RHOB) log measurements and the component volume fraction of kerogen. The linear regression 106 shown in FIG. 1B includes a regression coefficient of 0.41. In various embodiments, the identified linear regression 106 is compared to the data points (represented as dots in FIG. 1B) to determine whether the linear regression 106 represents a valid, predictive empirical relationship between the RHOB log measurements and the component volume fraction of kerogen. According to the embodiment shown in FIG. 1B, because the data points are within close proximity to the linear regression 106, the linear regression 106 does represent a valid empirical relationship that may be used to augment the multi-mineral, multi-fluid interpretation model and, thus, reduce the uncertainty in the model results obtained during the second step. Specifically, the linear regression 106 may be used as an additional equation that further constrains the problem, thus reducing the non-uniqueness of the solution.

Similarly, FIG. 1C is a graph 108 of a linear regression 110 that represents a potential empirical relationship between the core TOC data (expressed in units of dry weight fraction (dw)) and the component volume fraction of pyrite. The linear regression 110 shown in FIG. 1C includes a regression coefficient of 0.32. In various embodiments, the identified linear regression 110 is compared to the data points (represented as dots in FIG. 1C) to determine whether the linear regression 110 represents a valid, predictive empirical relationship between the core TOC data and the component volume fraction of pyrite. According to the embodiment shown in FIG. 1C, because many of the data points are not within close proximity to the linear regression 110, the linear regression 110 does not represent a valid empirical relationship. Therefore, the linear regression 110 is not helpful for reducing the uncertainty in the model results obtained during the second step.

According to embodiments described herein, the end-member calibration may be performed log-by-log and zone-by-zone within a single well. Alternatively, the end-member calibration may be performed log-by-log and zone-by-zone across multiple wells. For example, to increase the number of available component volume fractions obtained from the core data and/or the specialized log data, it may be desirable to perform end-member calibration simultaneously for multiple wells that are located relatively close to one another, since remotely-located wells are at an increased risk of having significant geological differences. As used herein, the term “analogous subsurface region” is generally used to refer to wells, zones, and/or other subsurface regions that are closely located and/or do not have significant geological differences that may affect the accuracy of mineralogy interpretation techniques.

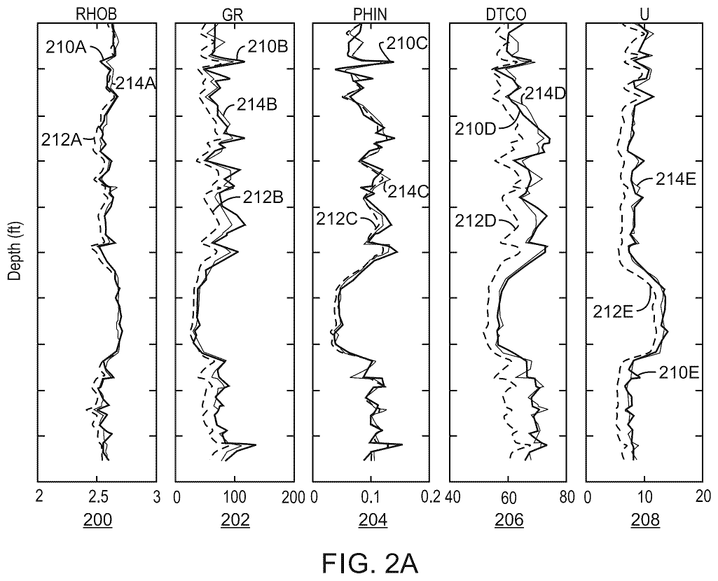

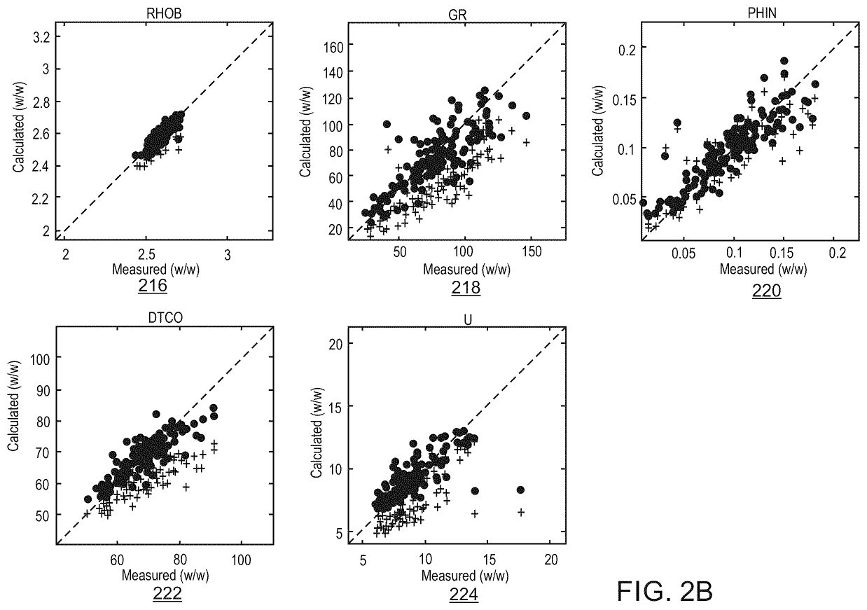

FIGS. 2A and 2B relate to an exemplary implementation of an end-member calibration process that was performed using core XRD, TOC, and GRI porosity and saturation data acquired from three wells penetrating a north American unconventional reservoir. Specifically, FIG. 2A includes graphs comparing the actual log measurements for each log type to the log measurements predicted using the default end-members and the component volume fractions from core measurements, and the log measurements predicted using the calibrated end-members and the component volume fractions from core measurements. In particular, FIG. 2A includes a first graph 200 for the RHOB log, a second graph 202 for the GR log, a third graph 204 for the PHIN log, a fourth graph 206 for the DTCO log, and a fifth graph 208 for the photoelectric absorption (U) log. Moreover, each graph 200, 202, 204, 206, and 208 includes a log measurement line 210A-E, which shows the actual log measurements, a default end-member line 212A-E, which shows the log measurements predicted using the default end-members and the component volume fractions from core measurements, and a calibrated end-member line 214A-E, which shows the log measurements predicted using the calibrated end-members described herein and the component volume fractions from core measurements. Similarly, FIG. 2B includes graphs showing cross plots of the log measurements for each log type, wherein the graphs include a comparison of particular measured log measurements against particular log measurements predicted using the default end-members and the component volume fractions from core measurements, and log measurements predicted using the calibrated end-members and the component volume fractions from core measurements. In particular, FIG. 2B includes a first graph 216 for the RHOB log, a second graph 218 for the GR log, a third graph 220 for the PHIN log, a fourth graph 222 for the DTCO log, and a fifth graph 224 for the photoelectric absorption (U) log. Moreover, each graph 216, 218, 220, 222, and 224 includes log measurements predicted using the default end-members and component volume fractions from core measurements, which are represented as crosses in FIG. 2B, and particular log measurements predicted using the calibrated end-members described herein and component volume fractions from core measurements, which are represented as dots in FIG. 2B.

As revealed by FIGS. 2A and 2B, the calibrated end-members described herein provide a much closer approximation to the actual log measurements than the default end-members used according to previous techniques. Moreover, according to embodiments described herein, the accuracy of the calibrated end-members may be periodically (or continuously) improved by adding new core data and/or new specialized log data from additional wells, zones, and/or depths at any time during the mineralogy interpretation process. In this manner, embodiments described herein provide for the generation of a well-defined, robust, and highly-predictive multi-mineral, multi-fluid interpretation model for the set of log types. Furthermore, by using the inversion algorithm described herein, embodiments described herein allow the end-members to be calibrated quickly and efficiently via an automated process, rather than relying on the manual input of end-members as required by previous techniques.

Moving now to the second step of the calibrated mineralogy interpretation techniques described herein, the generated multi-mineral, multi-fluid interpretation model, which includes the calibrated end-members (and, optionally, the empirical relationships identified during the first step), is used to solve the inverse problem for quantifying component volume fractions within one or more analogous subsurface regions that correspond to a specific log response. In various embodiments, this is accomplished by using the calibrated end-members, R, from the first step to solve the inverse problem shown in Equation (5) at each depth k, where g(v^{k}) are the predicted set of log measurements considering component volume fractions v^{k}.

$${min}_{0 < v < 1} {‖ W ( - g ( {v}^{k} ) ) ‖}_{2}^{2} \qquad ( 5 )$$

In Equation (5), the diagonal weighting matrix W_{i,i}=1/σᵢ, is used to account for measurement noise in the [symbol] measurements. Oftentimes (but not always) g(v^{k}) are a set of linear mixing laws between the component volume fractions in v^{k} and the logs end-members R; such that Equation (6) is obtained.

$$g ( {v}^{k} ) = R . {v}^{k} = [ \begin{matrix}{R}_{1 , 1} & … & {R}_{1 , i} & … & {R}_{1 , I} \\ ⋮ & ⋱ & & & ⋮ \\ {R}_{l , 1} & & {R}_{l , I} & & {R}_{l , I} \\ ⋮ & & & ⋱ & ⋮ \\ {R}_{L , 1} & … & {R}_{L , 1} & … & {R}_{L , I}\end{matrix} ] \cdot [ \begin{matrix}{v}_{1}^{k} \\ ⋮ \\ {v}_{i}^{k} \\ ⋮ \\ {v}_{I}^{k}\end{matrix} ] \qquad ( 6 )$$

However, in practice, Equation (5) is typically ill-conditioned and prone to non-uniqueness, meaning that there is some degree of inherent uncertainty in the results obtained using the model.

According to embodiments described herein, this inherent uncertainty is utilized to provide more accurate results for the mineralogy interpretation process. Specifically, since the solution is non-unique, the results are provided as a range of solutions that provide the best fit or, in other words, minimize the overall data misfit inherent within the model.

In various embodiments, this is accomplished using an inversion model weighting methodology, where for each inverted component, the component volume fractions that minimize the overall data misfit are identified. The goal is to identify, for each component i, the range of possible component volume fractions μ, that fit the log data adequately (i.e., that yield an acceptable misfit) considering the volume fraction inversion results for the other components. According to this methodology and considering the example of linear mixing law relationships between the component volume fractions in v^{k} and the logs end-members R, Equation (7) is solved for each component i.

$$v ( μ ) = {min}_{0 \leq v \leq 1} ( {‖ W ( \tilde{d} - Rv ) ‖}_{2}^{2} + {{H}^{2} ( {u}^{T} v - 1 )}^{2} + {{H}^{2} ( {r}^{T} v - μ )}^{2} ) \qquad ( 7 )$$

In Equation (7), r is a (I*1) vector of zeros, except at the i^{th} position, where it is 1. This amounts to enforcing vᵢ=μ, thereby performing a sensitivity analysis on the acceptable volume fractions for each component i, or in other words, focusing on the uncertainty of the volume fraction for each component. In matrix form, this problem can be rewritten as shown in Equation (8), where H is a large weight that ensures the conditions Σᵢ vᵢ=1 and vᵢ=μ are enforced.

$${min}_{0 \leq v \leq 1} {‖ [ \begin{matrix}W R \\ H {u}^{T} \\ H {r}^{T}\end{matrix} ] v - [ \begin{matrix}W d \\ H \\ H μ\end{matrix} ] ‖}_{2}^{2} \qquad ( 8 )$$

Moreover, Equation (8) can be solved using the Bounded Variable Least Squares algorithm. By calculating v(μ) for each component i, of the problem, Equation (9), which represents the misfit functions for each component i, is derived.

$${χ}_{i}^{2} ( μ ) = {‖ W ( \tilde{d} - R v ( μ ) ) ‖}_{2}^{2} \qquad ( 9 )$$

Therefore, for each component i, the acceptable range of component volume fractions is searched to identify the range of component volume fractions that minimize the overall misfit resulting from the inverted values for the other components. Moreover, the uncertainty attached to each component volume fraction vᵢ, can be evaluated using two separate methods. According to the first method, the component volume fractions that satisfy a desired level of χ-squared misfit are identified. In a simple least squares problem, it is typical to select χ²=v=m−I, where v is the degree of freedom m is the number of observations, and/is the number of components or unknowns. However, because it is not unusual to encounter m<I, it is desirable to use χ²=m instead. Accordingly, for each component, i, the function χ²(μ)/m is searched for the lower and upper intersection with the value of 1 to obtain the lower and upper volume fraction bounds that yield the desired level of χ-squared misfit. Alternatively, according to the second method, lower and upper bounds for each component volume fraction, vᵢ, are derived from the identification of the χ-squared minimum plateau for each component, i.

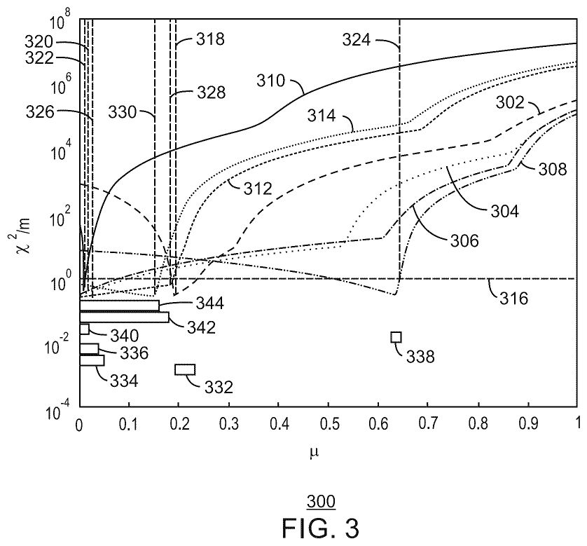

FIG. 3 is a graph 300 showing the manner in which the lowest misfit for each component volume fraction may be determined for the exemplary implementation of the calibrated mineralogy interpretation techniques described herein. In particular, FIG. 3 shows an example of χ²/m versus μ for the component volume fraction interpretation of a Permian well at a selected depth, k, of 6,434.5 feet within the Bonespring formation. Within the graph 300, a first line 302 corresponds to χ²/m versus μ for the component volume fraction of clay; a second line 304 corresponds to χ²/m versus μ for the component volume fraction of calcite; a third line 306 corresponds to χ²/m versus μ for the component volume fraction of dolomite; a fourth line 308 corresponds to χ²/m versus μ for the component volume fraction of QFM; a fifth line 310 corresponds to χ²/m versus μ for the component volume fraction of pyrite; and a sixth line 312 corresponds to χ²/m versus μ for the component volume fraction of kerogen; and a seventh line 314 corresponds to χ²/m versus μ for the component volume fraction of fluid. The horizontal dashed line 316 represents χ²=m. In addition, the vertical dashed lines 318, 320, 322, 324, 326, 328, and 330 represent the lowest misfits (i.e., the best fits) for the component volume fractions corresponding to lines 302, 304, 306, 308,310, 312, and 314, respectively. Moreover, the error bars 332, 334, 336, 338, 340, 342, and 344 correspond to the χ-squared minimum plateaus for the component volume fractions corresponding to lines 302, 304, 306, 308, 310, 312, and 314, respectively.

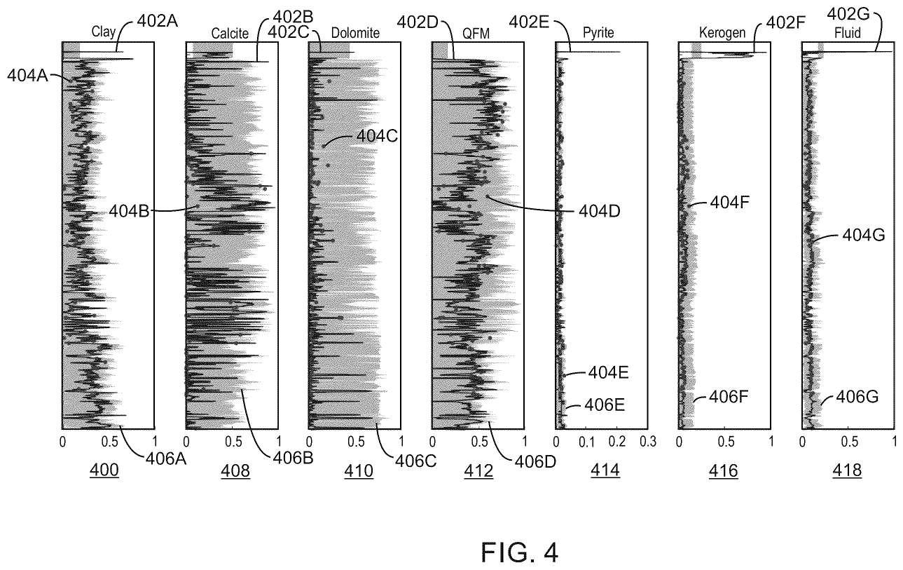

According to embodiments described herein, the identification of acceptable ranges of component volume fractions, as described with respect to FIG. 3, is performed at each depth of interest to deliver the overall component volume fraction profile for each component, as described with respect to FIG. 4. Specifically. FIG. 4 includes graphs showing the component volume fraction profiles for the exemplary implementation of the calibrated mineralogy interpretation techniques described herein. Within FIG. 4, a first graph 400 shows the component volume fraction profile of clay, with the best fit for the component volume fraction profile shown at line 402A, the core data points shown as dots 404A, and the uncertainty shown at 406A as the shaded area surrounding the line 402A and the dots 404A. A second graph 408 shows the component volume fraction profile of calcite, with the best fit for the component volume fraction profile shown at line 402B, the core data points shown as dots 404B, and the uncertainty shown at 406B. A third graph 410 shows the component volume fraction profile of dolomite, with the best fit for the component volume fraction profile shown at line 402C, the core data points shown as dots 404C, and the uncertainty shown at 406C. A fourth graph 412 shows the component volume fraction profile of QFM, with the best fit for the component volume fraction profile shown at line 402D, the core data points shown as dots 404D, and the uncertainty shown at 406D. A fifth graph 414 shows the component volume fraction profile of pyrite, with the best fit for the component volume fraction profile shown at line 402E, the core data points shown as dots 404E, and the uncertainty shown at 406E. A sixth graph 416 shows the component volume fraction profile of kerogen, with the best fit for the component volume fraction profile shown at line 402F, the core data points shown as dots 404F, and the uncertainty shown at 406F. Finally, a seventh graph 418 shows the component volume fraction profile for the fluid, with the best fit for the component volume fraction profile shown at line 402G, the core data points shown as dots 404G, and the uncertainty shown at 406G.

In various embodiments, the lines 402A-G represent the lowest misfit (or best fit) for each component volume fraction at each depth of interest, while the uncertainty 406A-G represents the error corresponding to the χ-squared minimum plateau for the component volume fraction at each depth, as described with respect to FIG. 3. In this manner, embodiments described herein provide improved accuracy over previous techniques by outputting a specific range of possible solutions for the component volume fractions at each depth. Moreover, as described herein, the range of possible solutions may be narrowed by using the empirical relationships identified during the calibration step to augment the model and, thus, reduce the non-uniqueness of the solution.

### Improved Method for Calibrated Multi-Mineral, Multi-Fluid Interpretation

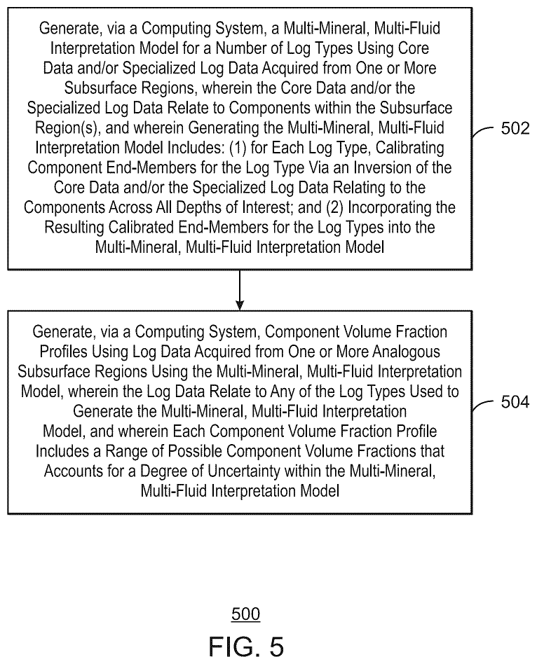

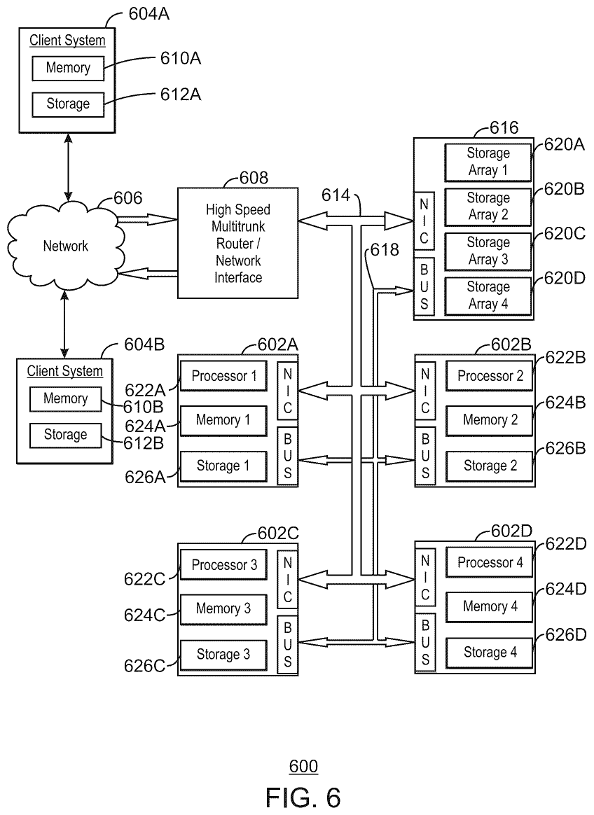

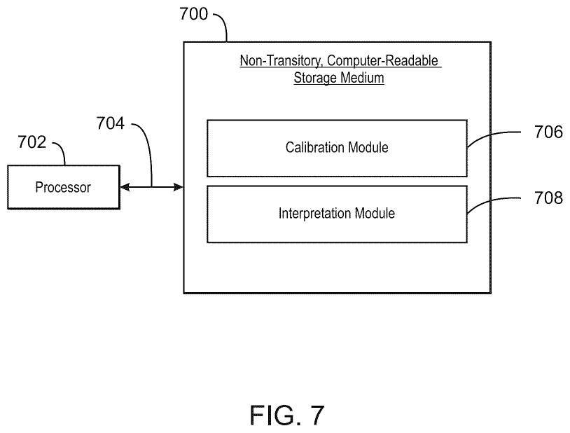

FIG. 5 is a process flow diagram of a method 500 for calibrated multi-mineral, multi-fluid interpretation. In various embodiments, the method 500 is executed by a computing system, such as the cluster computing system 600 described with respect to FIG. 6. In particular, in various embodiments, the computing system includes one or more processors and one or more non-transitory, computer-readable storage media, such as the non-transitory, computer-readable storage medium 700 of FIG. 7, including code configured to direct the processor to perform the steps of the method 500.

The method 500 begins at block 502, at which a multi-mineral, multi-fluid interpretation model is generated for a number of log types using core data and/or specialized log data acquired from one or more subsurface regions, wherein the core data and/or the specialized log data relate to components within the subsurface region(s). According to embodiments described herein, generating the multi-mineral, multi-fluid interpretation model includes: (1) for each log type, calibrating component end-members for the log type via an inversion of the core data and/or the specialized log data relating to the components across all depths of interest; and (2) incorporating the resulting calibrated end-members for the log types into the multi-mineral, multi-fluid interpretation model.

In some embodiments, the log types may include, but are not limited to, any combination of a reconstructed bulk density (RHOB) log type, a gamma ray (GR) log type, a neutron porosity (PHIN) log type, a compressional slowness (DTCO) log type, a photoelectric absorption (U) log type, a shear acoustic (DTSH) log type, a photoelectric factor (PE) log type, a resistivity log type, a conductivity log type, a spectral gamma ray log type, a capture cross-section (SIGMA) log type, or an elemental spectroscopy log type. In some embodiments, the core data may include, but are not limited to, core X-ray diffraction (XRD) data, core total organic carbon (TOC) data, and/or porosity and saturation data derived from conventional or crushed rock analysis (GRI) methods. In addition, in some embodiments, the specialized log data may include, but are not limited to, field-calibrated mineralogy log data interpreted using specialized spectroscopy log measurements, as described in U.S. Pat. No. 10,705,246 B2 to Guo and Luycx. Furthermore, in some embodiments, the components may include, but are not limited to, minerals, organic matter, or fluids; and the minerals may include, but are not limited to, clay, calcite, dolomite, quartz, feldspar, pyrite, or mineral groups such as quartz-feldspar-mica (QFM) or carbonate.

In various embodiments, several additional steps are performed during calibration of the end-members. The first step includes generating one or more linear regressions between at least two component volume fractions obtained from the core data and/or the specialized log data, and/or between at least one component volume fraction obtained from the core data and/or the specialized log data and additional log data acquired at corresponding depths of interest within the subsurface region(s). The second step includes determining whether each of the one or more linear regressions represents a valid empirical relationship between the at least two component volume fractions obtained from the core data and/or the specialized log data, and/or between the at least one component volume fraction obtained from the core data and/or the specialized log data and the additional log data acquired at corresponding depths of interest within the subsurface region(s). The third step includes reducing the degree of uncertainty within the multi-mineral, multi-fluid interpretation model by augmenting the model with any of the one or more linear regressions that represent the valid empirical relationships.

In some embodiments, the component end-members are re-calibrated in response to an addition of at least one of new core data or new specialized log data corresponding to at least one of an additional subsurface region or an additional depth of interest. In addition, in some embodiments, the multi-mineral, multi-fluid interpretation model is expanded by calibrating additional end-members in response to acquiring an additional log type and/or identifying additional components by acquiring new core data and/or new specialized log data.

At block 504, component volume fraction profiles are generated using log data acquired from one or more analogous subsurface regions using the multi-mineral, multi-fluid interpretation model, wherein the log data relate to any of the log types used to generate the multi-mineral, multi-fluid interpretation model, and wherein each component volume fraction profile includes a range of possible component volume fractions that accounts for a degree of uncertainty within the multi-mineral, multi-fluid interpretation model.

In various embodiments, the component volume fraction profiles are generated via an inversion of the log data acquired from the analogous subsurface region(s) using the multi-mineral, multi-fluid interpretation model, as described herein. Furthermore, in various embodiments, the range of possible component volume fractions for each component are identified by selecting the range of component volume fractions that minimizes an overall data misfit within results obtained using the multi-mineral, multi-fluid interpretation model. In such embodiments, identifying the range of possible component volume fractions for each component may include identifying the component volume fractions that satisfy a desired level of χ-squared misfit, and/or calculating a χ-squared minimum plateau for the component volume fractions and deriving a lower bound and an upper bound for the component volume fractions based on the χ-squared minimum plateau.

The process flow diagram of FIG. 5 is not intended to indicate that the steps of the method 500 are to be executed in any particular order, or that all of the steps of the method 500 are to be included in every case. Moreover, any number of additional steps not shown in FIG. 5 may be included within the method 500, depending on the details of the specific implementation.

Exemplary Cluster Computing System for Implementing Calibrated Mineralogy Interpretation Techniques Described Herein

FIG. 6 is a block diagram of an exemplary cluster computing system 600 that may be utilized to implement the calibrated mineralogy interpretation techniques described herein. The exemplary cluster computing system 600 shown in FIG. 6 has four computing units 602A, 602B, 602C, and 602D, each of which may perform calculations for a portion of the calibrated mineralogy interpretation techniques described herein. However, one of ordinary skill in the art will recognize that the cluster computing system 600 is not limited to this configuration, as any number of computing configurations may be selected. For example, a smaller analysis may be run on a single computing unit, such as a workstation, while a large calculation may be run on a cluster computing system 600 having tens, hundreds, thousands, or even more computing units.

The cluster computing system 600 may be accessed from any number of client systems 604A and 604B over a network 606, for example, through a high-speed network interface 608. The computing units 602A to 602D may also function as client systems, providing both local computing support and access to the wider cluster computing system 600.

The network 606 may include a local area network (LAN), a wide area network (WAN), the Internet, or any combinations thereof. Each client system 604A and 604B may include one or more non-transitory, computer-readable storage media for storing the operating code and program instructions that are used to implement the calibrated mineralogy interpretation techniques described herein. For example, each client system 604A and 604B may include a memory device 610A and 610B, which may include random access memory (RAM), read only memory (ROM), and the like. Each client system 604A and 604B may also include a storage device 612A and 612B, which may include any number of hard drives, optical drives, flash drives, or the like.

The high-speed network interface 608 may be coupled to one or more buses in the cluster computing system 600, such as a communications bus 614. The communication bus 614 may be used to communicate instructions and data from the high-speed network interface 608 to a cluster storage system 616 and to each of the computing units 602A to 602D in the cluster computing system 600. The communications bus 614 may also be used for communications among the computing units 602A to 602D and the cluster storage system 616. In addition to the communications bus 614, a high-speed bus 618 can be present to increase the communications rate between the computing units 602A to 602D and/or the cluster storage system 616.

The cluster storage system 616 can have one or more non-transitory, computer-readable storage media, such as storage arrays 620A, 620B, 620C and 620D for the storage of models (including the calibrated multi-mineral, multi-fluid interpretation models described herein), data (including core data and/or log data relating to one or more wells), visual representations (such as visual representations of the generated interpretation models), results (such as graphs, charts, and the like used to convey results obtained using the calibrated multi-mineral, multi-fluid interpretation models described herein), code (including code for generating and utilizing the calibrated multi-mineral, multi-fluid interpretation models described herein), and other information concerning the implementation of the calibrated mineralogy interpretation techniques described herein. The storage arrays 620A to 620D may include any combinations of hard drives, optical drives, flash drives, or the like.

Each computing unit 602A to 602D can have a processor 622A, 622B, 622C and 622D and associated local non-transitory, computer-readable storage media, such as a memory device 624A, 624B, 624C and 624D and a storage device 626A, 626B, 626C and 626D. Each processor 622A to 622D may be a multiple core unit, such as a multiple core central processing unit (CPU) or a graphics processing unit (GPU). Each memory device 624A to 624D may include ROM and/or RAM used to store program instructions for directing the corresponding processor 622A to 622D to implement the calibrated mineralogy interpretation techniques described herein. Each storage device 626A to 626D may include one or more hard drives, optical drives, flash drives, or the like. In addition, each storage device 626A to 626D may be used to provide storage for models, intermediate results, data, images, or code associated with operations, including code used to implement the calibrated mineralogy interpretation techniques described herein.

The present techniques are not limited to the architecture or unit configuration illustrated in FIG. 6. For example, any suitable processor-based device may be utilized for implementing all or a portion of embodiments of the calibrated mineralogy interpretation techniques described herein, including without limitation personal computers, laptop computers, computer workstations, mobile devices, and multi-processor servers or workstations with (or without) shared memory. Moreover, embodiments may be implemented on application specific integrated circuits (ASICs) or very-large-scale integrated (VLSI) circuits. In fact, persons of ordinary skill in the art may utilize any number of suitable structures capable of executing logical operations according to embodiments described herein.

FIG. 7 is a block diagram of an exemplary non-transitory, computer-readable storage medium 700 that may be used for the storage of data and modules of program instructions for implementing the calibrated mineralogy interpretation techniques described herein. The non-transitory, computer-readable storage medium 700 may include a memory device, a hard disk, and/or any number of other devices, as described with respect to FIG. 6. A processor 702 may access the non-transitory, computer-readable storage medium 700 over a bus or network 704. While the non-transitory, computer-readable storage medium 700 may include any number of modules (and sub-modules) for implementing the techniques described herein, in some embodiments, the non-transitory, computer-readable storage medium 700 includes a calibration module 706 for generating a calibrated multi-mineral, multi-fluid interpretation model and an interpretation module 708 for generating component volume fraction profiles using the generated model.

### Advantages of Calibrated Mineralogy Interpretation Techniques

An advantage of the calibrated multi-mineral, multi-fluid interpretation model described herein is that, because the end-members are automatically calibrated rather than manually updated, the model can be built much faster than models built according to previous techniques. In addition, because the end-members are calibrated on a log-by-log basis (i.e. the calibrated end-members for each log type are independent of the end-members of the other log types), the model described herein is more accurate and predictive than models built according to previous techniques.

Another advantage is that the end-members can be calibrated on a multi-well and/or multi-zone basis. In various embodiments, this allows the calibrated multi-mineral, multi-fluid interpretation model to be used to predict component volume fraction profiles for multiple wells and/or multiple zones simultaneously, particularly in the case of wells and/or zones that are closely located and, thus, are likely to have the same general geophysical properties. Moreover, in various embodiments, leveraging core data points from multiple wells and/or multiple zones results in the generation of more accurate and robust end-members and, therefore, a more accurate multi-mineral, multi-fluid interpretation model.

Another advantage is that embodiments described herein allow empirical relationships between particular component volume fractions (and/or between the log measurements and particular component volume fractions) to be automatically determined during the calibration process. During the interpretation process, such empirical relationships can then be used to reduce the non-uniqueness of the solution or, in other words, to reduce the amount of uncertainty in the resulting component volume fraction profiles.

Furthermore, another advantage is that embodiments described herein provide depth-by-depth uncertainty ranges, or error bars, for the volume fraction of each component. Thus, the range of solutions provided according to embodiments described herein is much richer and more informative than the solutions provided by previous techniques, which typically ignore the inherent uncertainty and provide a single volume fraction solution for each component.

### Exemplary Embodiments of Present Techniques

In one or more embodiments, the present techniques may be susceptible to various modifications and alternative forms, such as the following embodiments as noted in paragraphs 1 to 15:

1. A method for calibrated multi-mineral, multi-fluid interpretation, comprising: generating, via a computing system, a multi-mineral, multi-fluid interpretation model for a plurality of log types using at least one of core data or specialized log data acquired from one or more subsurface regions, wherein the at least one of the core data or the specialized log data relate to components within the one or more subsurface regions, and wherein generating the multi-mineral, multi-fluid interpretation model comprises: for each log type, calibrating component end-members for the log type via an inversion of the at least one of the core data or the specialized log data relating to the components across all depths of interest; and incorporating the resulting calibrated end-members for the plurality of log types into the multi-mineral, multi-fluid interpretation model; and generating, via the computing system, component volume fraction profiles using log data acquired from one or more analogous subsurface regions using the multi-mineral, multi-fluid interpretation model, wherein the log data relate to any of the plurality of log types used to generate the multi-mineral, multi-fluid interpretation model, and wherein each component volume fraction profile comprises a range of possible component volume fractions that accounts for a degree of uncertainty within the multi-mineral, multi-fluid interpretation model.
2. The method of paragraph 1, wherein generating the multi-mineral, multi-fluid interpretation model further comprises performing the following during calibration of the end-members: generating one or more linear regressions between at least two component volume fractions obtained from the at least one of the core data or the specialized log data, and/or between at least one component volume fraction obtained from the at least one of the core data or the specialized log data and additional log data acquired at corresponding depths of interest within the one or more subsurface regions; determining whether each of the one or more linear regressions represents a valid empirical relationship between the at least two component volume fractions obtained from the at least one of the core data or the specialized log data, and/or between the at least one component volume fraction obtained from the at least one of the core data or the specialized log data and the additional log data acquired at the corresponding depths of interest within the one or more subsurface regions; and reducing the degree of uncertainty within the multi-mineral, multi-fluid interpretation model by augmenting the multi-mineral, multi-fluid interpretation model with any of the one or more linear regressions that represent the valid empirical relationships.
3. The method of paragraph 1 or 2, comprising re-calibrating the end-members in response to an addition of at least one of new core data or new specialized log data corresponding to at least one of an additional subsurface region or an additional depth of interest.
4. The method of any of paragraphs 1 to 3, comprising expanding the multi-mineral, multi-fluid interpretation model by calibrating additional end-members in response to at least one of: acquiring an additional log type; or identifying additional components by acquiring at least one of new core data or new specialized log data.
5. The method of any of paragraphs 1 to 4, comprising generating the component volume fraction profiles via an inversion of the log data acquired from the one or more analogous subsurface regions using the multi-mineral, multi-fluid interpretation model.
6. The method of any of paragraphs 1 to 5, comprising identifying the range of possible component volume fractions for each component by selecting the range of component volume fractions that minimizes an overall data misfit within results obtained using the multi-mineral, multi-fluid interpretation model.
7. The method of paragraph 6, wherein identifying the range of possible component volume fractions for each component comprises at least one of: identifying the component volume fractions that satisfy a desired level of χ-squared misfit; or calculating a χ-squared minimum plateau for the component volume fractions and deriving a lower bound and an upper bound for the component volume fractions based on the χ-squared minimum plateau.
8. The method of any of paragraphs 1 to 7, wherein the plurality of log types comprise any combination of a reconstructed bulk density (RHOB) log type, a gamma ray (GR) log type, a neutron porosity (PHIN) log type, a compressional slowness (DTCO) log type, a photoelectric absorption (U) log type, a shear acoustic (DTSH) log type, a photoelectric factor (PE) log type, a resistivity log type, a conductivity log type, a spectral gamma ray log type, a capture cross-section (SIGMA) log type, or an elemental spectroscopy log type.
9. The method of any of paragraphs 1 to 8, wherein the core data comprise at least one of core X-ray diffraction (XRD) data, core total organic carbon (TOC) data, or porosity and saturation data derived from conventional or crushed rock analysis (GRI) methods.
10. The method of any of paragraphs 1 to 9, wherein the specialized log data comprise field-calibrated mineralogy log data interpreted using specialized spectroscopy log measurements.
11. The method of any of paragraphs 1 to 10, wherein the components comprise at least one of minerals, organic matter, or fluids; and wherein the minerals comprise at least one of clay, calcite, dolomite, quartz, feldspar, pyrite, or mineral groups such as quartz-feldspar-mica or carbonate.
12. A computing system, comprising: a processor; and a non-transitory, computer-readable storage medium, comprising code configured to direct the processor to: generate a multi-mineral, multi-fluid interpretation model for a plurality of log types using at least one of core data or specialized log data acquired from one or more subsurface regions, wherein the at least one of the core data or the specialized log data relate to components within the one or more subsurface regions, and wherein generating the multi-mineral, multi-fluid interpretation model comprises: for each log type, calibrating component end-members for the log type via an inversion of the at least one of the core data or the specialized log data relating to the components across all depths of interest; and incorporating the resulting calibrated end-members for the plurality of log types into the multi-mineral, multi-fluid interpretation model; and generate component volume fraction profiles using log data acquired from one or more analogous subsurface regions using the multi-mineral, multi-fluid interpretation model, wherein the log data relate to any of the plurality of log types used to generate the multi-mineral, multi-fluid interpretation model, and wherein each component volume fraction profile comprises a range of possible component volume fractions that accounts for a degree of uncertainty within the multi-mineral, multi-fluid interpretation model.
13. The computing system of paragraph 12, wherein the non-transitory, computer-readable storage medium further comprises code configured to direct the processor to generate the multi-mineral, multi-fluid interpretation model by: generating one or more linear regressions between at least two component volume fractions obtained from the at least one of the core data or the specialized log data, and/or between at least one component volume fraction obtained from the at least one of the core data or the specialized log data and additional log data acquired at corresponding depths of interest within the one or more subsurface regions; determining whether each of the one or more linear regressions represents a valid empirical relationship between the at least two component volume fractions obtained from the at least one of the core data or the specialized log data, and/or between the at least one component volume fraction obtained from the at least one of the core data or the specialized log data and the additional log data acquired at the corresponding depths of interest within the one or more subsurface regions; and reducing the degree of uncertainty within the multi-mineral, multi-fluid interpretation model by augmenting the multi-mineral, multi-fluid interpretation model with any of the one or more linear regressions that represent the valid empirical relationships.
14. The computing system of paragraph 12 or 13, wherein the non-transitory, computer-readable storage medium further comprises code configured to direct the processor to identify the range of possible component volume fractions for each component by selecting the range of component volume fractions that minimizes an overall data misfit within results obtained using the multi-mineral, multi-fluid interpretation model.
15. The computing system of paragraph 14, wherein the non-transitory, computer-readable storage medium further comprises code configured to direct the processor to identify the range of possible component volume fractions for each component by performing at least one of: identifying the component volume fractions that satisfy a desired level of χ-squared misfit; or calculating a χ-squared minimum plateau for the component volume fractions and deriving a lower bound and an upper bound for the component volume fractions based on the χ-squared minimum plateau.

Moreover, while the embodiments described herein are well-calculated to achieve the advantages set forth, it will be appreciated that such embodiments are susceptible to modification, variation, and change without departing from the spirit thereof. Indeed, the present techniques include all alternatives, modifications, and equivalents falling within the true spirit and scope of the appended claims.

What is claimed is:

1. A method for calibrated multi-mineral, multi-fluid interpretation, comprising:
generating, via a computing system, a multi-mineral, multi-fluid interpretation model for a plurality of log types using at least one of core data or specialized log data acquired from one or more subsurface regions, wherein the at least one of the core data or the specialized log data relate to components within the one or more subsurface regions, and wherein generating the multi-mineral, multi-fluid interpretation model comprises:
for each log type, calibrating component end-members for the log type via an inversion of the at least one of the core data or the specialized log data relating to the components across all depths of interest; and
incorporating the resulting calibrated end-members for the plurality of log types into the multi-mineral, multi-fluid interpretation model; and
generating, via the computing system, component volume fraction profiles using log data acquired from one or more analogous subsurface regions using the multi-mineral, multi-fluid interpretation model, wherein the log data relate to any of the plurality of log types used to generate the multi-mineral, multi-fluid interpretation model, and wherein each component volume fraction profile comprises a range of possible component volume fractions that accounts for a degree of uncertainty within the multi-mineral, multi-fluid interpretation model.

2. The method of claim 1, wherein generating the multi-mineral, multi-fluid interpretation model further comprises performing the following during calibration of the end-members:
generating one or more linear regressions between at least two component volume fractions obtained from the at least one of the core data or the specialized log data, and/or between at least one component volume fraction obtained from the at least one of the core data or the specialized log data and additional log data acquired at corresponding depths of interest within the one or more subsurface regions;
determining whether each of the one or more linear regressions represents a valid empirical relationship between the at least two component volume fractions obtained from the at least one of the core data or the specialized log data, and/or between the at least one component volume fraction obtained from the at least one of the core data or the specialized log data and the additional log data acquired at the corresponding depths of interest within the one or more subsurface regions; and
reducing the degree of uncertainty within the multi-mineral, multi-fluid interpretation model by augmenting the multi-mineral, multi-fluid interpretation model with any of the one or more linear regressions that represent the valid empirical relationships.

3. The method of claim 1, comprising re-calibrating the end-members in response to an addition of at least one of new core data or new specialized log data corresponding to at least one of an additional subsurface region or an additional depth of interest.

4. The method of claim 1, comprising expanding the multi-mineral, multi-fluid interpretation model by calibrating additional end-members in response to at least one of:
acquiring an additional log type; or
identifying additional components by acquiring at least one of new core data or new specialized log data.

5. The method of claim 1, comprising generating the component volume fraction profiles via an inversion of the log data acquired from the one or more analogous subsurface regions using the multi-mineral, multi-fluid interpretation model.

6. The method of claim 1, comprising identifying the range of possible component volume fractions for each component by selecting the range of component volume fractions that minimizes an overall data misfit within results obtained using the multi-mineral, multi-fluid interpretation model.

7. The method of claim 6, wherein identifying the range of possible component volume fractions for each component comprises at least one of:
identifying the component volume fractions that satisfy a desired level of χ-squared misfit; or
calculating a χ-squared minimum plateau for the component volume fractions and deriving a lower bound and an upper bound for the component volume fractions based on the χ-squared minimum plateau.

8. The method of claim 1, wherein the plurality of log types comprise any combination of a reconstructed bulk density (RHOB) log type, a gamma ray (GR) log type, a neutron porosity (PHIN) log type, a compressional slowness (DTCO) log type, a photoelectric absorption (U) log type, a shear acoustic (DTSH) log type, a photoelectric factor (PE) log type, a resistivity log type, a conductivity log type, a spectral gamma ray log type, a capture cross-section (SIGMA) log type, or an elemental spectroscopy log type.

9. The method of claim 1, wherein the core data comprise at least one of core X-ray diffraction (XRD) data, core total organic carbon (TOC) data, or porosity and saturation data derived from conventional or crushed rock analysis (GRI) methods.

10. The method of claim 1, wherein the specialized log data comprise field-calibrated mineralogy log data interpreted using specialized spectroscopy log measurements.

11. The method of claim 1, wherein the components comprise at least one of minerals, organic matter, or fluids; and wherein the minerals comprise at least one of clay, calcite, dolomite, quartz, feldspar, pyrite, or mineral groups such as quartz-feldspar-mica or carbonate.

12. A computing system, comprising:
a processor; and
a non-transitory, computer-readable storage medium, comprising code configured to direct the processor to:
generate a multi-mineral, multi-fluid interpretation model for a plurality of log types using at least one of core data or specialized log data acquired from one or more subsurface regions, wherein the at least one of the core data or the specialized log data relate to components within the one or more subsurface regions, and wherein generating the multi-mineral, multi-fluid interpretation model comprises:
for each log type, calibrating component end-members for the log type via an inversion of the at least one of the core data or the specialized log data relating to the components across all depths of interest; and
incorporating the resulting calibrated end-members for the plurality of log types into the multi-mineral, multi-fluid interpretation model; and
generate component volume fraction profiles using log data acquired from one or more analogous subsurface regions using the multi-mineral, multi-fluid interpretation model, wherein the log data relate to any of the plurality of log types used to generate the multi-mineral, multi-fluid interpretation model, and wherein each component volume fraction profile comprises a range of possible component volume fractions that accounts for a degree of uncertainty within the multi-mineral, multi-fluid interpretation model.

13. The computing system of claim 12, wherein the non-transitory, computer-readable storage medium further comprises code configured to direct the processor to generate the multi-mineral, multi-fluid interpretation model by:
generating one or more linear regressions between at least two component volume fractions obtained from the at least one of the core data or the specialized log data, and/or between at least one component volume fraction obtained from the at least one of the core data or the specialized log data and additional log data acquired at corresponding depths of interest within the one or more subsurface regions;
determining whether each of the one or more linear regressions represents a valid empirical relationship between the at least two component volume fractions obtained from the at least one of the core data or the specialized log data, and/or between the at least one component volume fraction obtained from the at least one of the core data or the specialized log data and the additional log data acquired at the corresponding depths of interest within the one or more subsurface regions; and
reducing the degree of uncertainty within the multi-mineral, multi-fluid interpretation model by augmenting the multi-mineral, multi-fluid interpretation model with any of the one or more linear regressions that represent the valid empirical relationships.

14. The computing system of claim 12, wherein the non-transitory, computer-readable storage medium further comprises code configured to direct the processor to identify the range of possible component volume fractions for each component by selecting the range of component volume fractions that minimizes an overall data misfit within results obtained using the multi-mineral, multi-fluid interpretation model.

15. The computing system of claim 14, wherein the non-transitory, computer-readable storage medium further comprises code configured to direct the processor to identify the range of possible component volume fractions for each component by performing at least one of:
identifying the component volume fractions that satisfy a desired level of χ-squared misfit; or
calculating a χ-squared minimum plateau for the component volume fractions and deriving a lower bound and an upper bound for the component volume fractions based on the χ-squared minimum plateau.

16. The computing system of claim 12, wherein the non-transitory, computer-readable storage medium further comprises code configured to direct the processor to re-calibrate the end-members in response to an addition of at least one of new core data or new specialized log data corresponding to at least one of an additional subsurface region or an additional depth of interest.

17. The computing system of claim 12, wherein the non-transitory, computer-readable storage medium further comprises code configured to direct the processor to expand the multi-mineral, multi-fluid interpretation model by calibrating additional end-members in response to at least one of:
acquiring an additional log type; or
identifying additional components by acquiring at least one of new core data or new specialized log data.

18. A non-transitory, computer-readable storage medium, comprising program instructions that are executable by a processor to cause the processor to:
generate a multi-mineral, multi-fluid interpretation model for a plurality of log types using at least one of core data or specialized log data acquired from one or more subsurface regions, wherein the at least one of the core data or the specialized log data relate to components within the one or more subsurface regions, and wherein generating the multi-mineral, multi-fluid interpretation model comprises:
for each log type, calibrating component end-members for the log type via an inversion of the at least one of the core data or the specialized log data relating to the components across all depths of interest; and
incorporating the resulting calibrated end-members for the plurality of log types into the multi-mineral, multi-fluid interpretation model; and
generate component volume fraction profiles using log data acquired from one or more analogous subsurface regions using the multi-mineral, multi-fluid interpretation model, wherein the log data relate to any of the plurality of log types used to generate the multi-mineral, multi-fluid interpretation model, and wherein each component volume fraction profile comprises a range of possible component volume fractions that accounts for a degree of uncertainty within the multi-mineral, multi-fluid interpretation model.

19. The non-transitory, computer-readable storage medium of claim 18, further comprising program instructions that are executable by the processor to cause the processor to generate the multi-mineral, multi-fluid interpretation model by:
generating one or more linear regressions between at least two component volume fractions obtained from the at least one of the core data or the specialized log data, and/or between at least one component volume fraction obtained from the at least one of the core data or the specialized log data and additional log data acquired at corresponding depths of interest within the one or more subsurface regions;
determining whether each of the one or more linear regressions represents a valid empirical relationship between the at least two component volume fractions obtained from the at least one of the core data or the specialized log data, and/or between the at least one component volume fraction obtained from the at least one of the core data or the specialized log data and the additional log data acquired at the corresponding depths of interest within the one or more subsurface regions; and
reducing the degree of uncertainty within the multi-mineral, multi-fluid interpretation model by augmenting the multi-mineral, multi-fluid interpretation model with any of the one or more linear regressions that represent the valid empirical relationships.

20. The non-transitory, computer-readable storage medium of claim 18, further comprising program instructions that are executable by the processor to cause the processor to identify the range of possible component volume fractions for each component by selecting the range of component volume fractions that minimizes an overall data misfit within results obtained using the multi-mineral, multi-fluid interpretation model.
